(19) United States
(12) Patent Application Publication
(10) Pub. No.: US 2009/0032548 A1
(43) Pub. Date: Feb. 5, 2009

(54) FUEL DISPENSER AND METHOD OF TEMPERATURE COMPENSATION IN A FUEL DISPENSER

(76) Inventors: Bengt I. Larsson, Skivarp (SE); Rickard Carlsson, Lund (SE)

Correspondence Address: FISH & RICHARDSON P.C., P.O. BOX 1022, MINNEAPOLIS, MN, 55440-1022, US

(21) Appl. No.: 12/145,233

(22) Filed: Jun. 24, 2008

(30) Foreign Application Priority Data
Jul. 12, 2007 (EP) 07112342.6

(51) Int. Cl. B67D 5/08; B67D 5/04; G01F 15/02

(52) U.S. Cl. 222/1; 222/54; 700/282

(57) ABSTRACT

A temperature compensating fuel dispenser comprises a fuel-handling compartment, an electronics compartment, a barrier separating said compartments, and at least two fuel lines in the fuel-handling compartment. Each fuel line is provided with a flow meter and a temperature sensor. The fuel dispenser has a compensator device for compensating a flow measured by the flow meters based on a temperature measured by the temperature sensors. A control unit is arranged in the electronics compartment connected to each flow meter by a respective communication line. The means for compensating the measured fuel flow comprises one compensator for each flow meter arranged in the fuel-handling compartment in connection with the respective flow meter. The communication lines are connected between the respective flow meters and the control unit through a common intrinsically safe passage in the barrier. A method for compensating a measured fuel flow for a temperature of the fuel is also disclosed.

### CLAIM OF PRIORITY

Under 35 U.S.C. § 119, this application claims the benefit of a foreign priority application filed in the European Patent Convention, serial number 07112342.6 filed Jul. 12, 2007, the entire contents of which are hereby incorporated by reference.

### TECHNICAL FIELD

The present application relates to temperature compensation in a fuel dispenser.

### BACKGROUND

The density of fuels, such as petrol or diesel, varies with the temperature of the fuel. In fuel dispensers it may be advisable to compensate the measured fuel volume for temperature variations, such that the customer pays approximately the same amount for the same quantity of energy regardless of the temperature of the fuel.

It is known to provide fuel dispensers with temperature compensation systems. One such temperature compensating fuel dispenser is described in U.S. Pat. No. 5,557,084. This fuel dispenser has a plurality of fuel lines in a fuel-handling compartment, each provided with a flow meter. A temperature sensor is arranged in connection with each flow meter in the fuel-handling compartment. Signals from the flow meters and the temperature sensors are sent to a computation device in an electronics compartment of the fuel dispenser. In the computation device, the temperature compensated flow is calculated based on the signals of measured flow and measured temperature. A disadvantage of this fuel compensating fuel dispenser is that a separate computing device has to be arranged in the electronics compartment, thus increasing the cost of manufacturing the fuel dispenser.

### SUMMARY OF THE INVENTION

In one aspect, the systems disclosed herein include a fuel dispenser comprising a fuel-handling compartment, an electronics compartment, a barrier separating the fuel-handling compartment from the electronics compartment, at least two fuel lines in the fuel-handling compartment, each fuel line being provided with a flow meter and a temperature sensor, a control unit in the electronics compartment connected to each flow meter by a respective communication line, each such communication line passing through a common intrinsically safe passage in the barrier, and a compensator device located in the fuel-handling compartment and connected to a flow meter for compensating a flow measured by a flow meter to which it is connected based on a temperature measured by at least one of the temperature sensors.

The device for compensating the measured fuel flow may comprise one compensator for each flow meter arranged in the fuel-handling compartment in connection with the respective flow meter. The communication lines may be connected between the respective flow meters and the control unit through a common intrinsically safe passage in the barrier between the fuel-handling compartment and the electronics compartment. In this manner, the measured fuel flow may be compensated for the temperature of the fuel without the need of a separate compensating device in the electronics compartment. Further, only one intrinsically safe passage through the barrier between the compartments need be provided.

In another aspect, each flow meter may comprise a pulse generator arranged to generate pulses corresponding to the fuel flow and each compensator may be arranged to compensate the number of pulses generated by the pulse generator based on the temperature measured by the temperature sensor. A pulse generator is a convenient means for transforming a flow into a transmittable and registerable signal and compensation of the number of pulses transmitted by the pulse generator is a simple and reliable way of compensating the measured flow.

The intrinsically safe passage may comprise a device for limiting a voltage and/or current through said intrinsically safe passage. This is a practical way of securing that the barrier properties of the barrier between the fuel-handling compartment and the electronics compartment are maintained.

Each compensator may be integrated in the respective flow meter. Hereby, the compensator can be arranged in the fuel dispenser in an effective way.

The barrier between the fuel-handling compartment and the electronics compartment may be a physical barrier. In this way, a safe barrier can easily be provided while reducing the dimensions of the fuel dispenser.

The barrier may alternatively be a separating distance between the fuel-handling compartment and the electronics compartment. Thus, no separate wall is needed, thereby reducing the material consumption for the production of the fuel dispenser.

In one aspect, the method disclosed herein may include a step of sending a signal corresponding to the compensated fuel flow through an intrinsically safe passage through the barrier from the fuel-handling compartment to a control unit in the electronics compartment. In this manner, the measured fuel flow is compensated already at the fuel flow meter and no separate compensating device is needed in the electronics compartment, thereby reducing the manufacturing cost of the fuel dispenser in which the method is used.

### BRIEF DESCRIPTION OF THE DRAWINGS

The invention will be described in more detail with reference to the drawing in which:

FIG. 1 is a diagram showing the main components of a fuel dispenser according to one embodiment of the invention.

### DETAILED DESCRIPTION OF PREFERRED EMBODIMENTS OF THE INVENTION

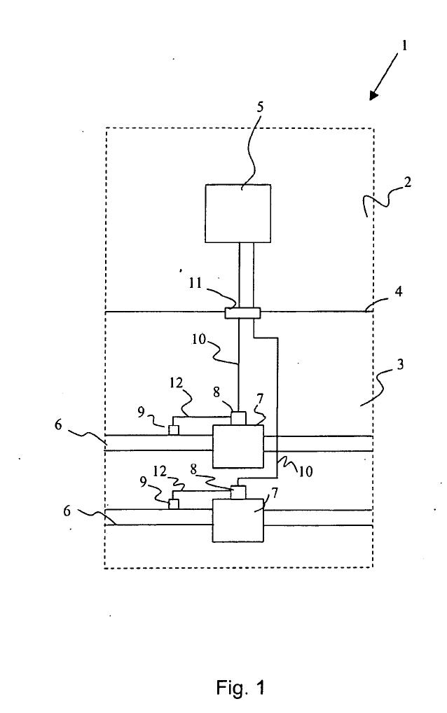

The fuel dispenser 1 of FIG. 1 is divided into an electronics compartment 2 and a fuel-handling compartment 3 by a barrier 4 in the form of a separating wall. A control unit 5 is arranged in the electronics compartment 2. Two fuel lines 6 pass through the fuel-handling compartment 3. Each fuel line 6 is provided with a flow meter 7 arranged to measure the fuel flow in the fuel line 6 and having a pulse generator 8. Each fuel line 6 is also provided with a temperature sensor 9. The pulse generator 8 is connected to the control unit 5 via a communication line 10 for transmitting signals from the pulse generator 8 to the control unit 5. The communication lines 10 from each pulse generator 8 all pass through the barrier 11 between the fuel-handling compartment 3 and the electronics compartment 2 through a common intrinsically safe passage 11. The intrinsically safe passage 11 typically consists of an electronic unit limiting the voltage and/or current passing through the barrier 4.

Each flow meter 7 typically has an impeller (not shown) that is rotated by the flowing fuel in the fuel line 6. A magnetic element on the impeller may be sensed by a Hall effect sensor arranged in the pulse generator 8 adjacent to the impeller. For each revolution of the impeller, a pulse is generated by the pulse generator 8. The temperature of the fuel flowing in the fuel line 6 is measured by the temperature sensor 9 and a corresponding signal is sent to the pulse generator 8 via a communication line 12. The pulse generator 8 has a local intelligence and makes a compensation of the number of pulses based on the temperature measured by the temperature sensor 9, such that a signal sent by the pulse generator 8 to the control unit 5 represents a temperature compensated flow. The local intelligence of the pulse generator 8 may include a preset table of compensation values for a suitable range of temperatures of the fuel. The compensation is done by skipping or adding a pulse at an interval of pulses appropriate for the measured temperature.

The signal from each pulse generator 8 is sent to the control unit 5 through the communication line 10. The communication lines 10 from all pulse generators 8 pass through the barrier 4 separating the fuel-handling compartment 3 and the electronics compartment 2 via the common intrinsically safe passage 11. Therefore, only one intrinsically safe passage 11 need be arranged for the passage through the barrier 4. Since the signals from the pulse generators 8 are compensated for the temperature at the pulse generators 8, there is no need for a separate computation device in the electronics compartment 2 for compensating the measured fuel flow.

The skilled person will recognize that a number of modifications of the embodiments described herein are possible without departing from the scope of the invention. For instance, the barrier 4 need not be a physical barrier, but could be a separating distance sufficient to safely separate the electronics compartment from the fuel-handling compartment.

In the description above, the flow meter 7 is described as being an impeller coupled to a pulse generator 8 with a Hall effect sensor, but other types of flow meters could of course also be used, such as ultrasonic flow meters or differential pressure flow meters or any other type of flow meter suitable for measuring fuel flow.

In the embodiment shown in FIG. 1, the fuel dispenser has two fuel lines 6, but the fuel dispenser could have more or less than two fuel lines with associated flow meters and pulse generators, with all communication lines to the control unit in the electronics compartment passing through the common intrinsically safe passage 11.

The local intelligence of the pulse generator could, in addition to temperature compensation, also be used, e.g., for compensating for manufacturing tolerances in the flow meter or for compensating for wear of the flow meter.

Other embodiments are within the scope of the following claims.

1. A fuel dispenser comprising a fuel-handling compartment;
an electronics compartment;
a barrier separating the fuel-handling compartment from the electronics compartment;
at least two fuel lines in the fuel-handling compartment, each fuel line being provided with a flow meter and a temperature sensor;
a control unit in the electronics compartment connected to each flow meter by a respective communication line, each such communication line passing through a common intrinsically safe passage in the barrier; and
a compensator device located in the fuel-handling compartment and connected to a flow meter for compensating a flow measured by a flow meter to which it is connected based on a temperature measured by at least one of the temperature sensors.

2. A fuel dispenser as claimed in claim 1, wherein each flow meter comprises a pulse generator adapted to generate pulses corresponding to the fuel flow and wherein each compensator is adapted to compensate the number of pulses generated by the pulse generator based on the temperature measured by the temperature sensor.

3. A fuel dispenser as claimed in claim 1, wherein the intrinsically safe passage comprises means for limiting a voltage and/or current through said intrinsically safe passage.

4. A fuel dispenser as claimed in claim 1, wherein each compensator is configured integrally with the flow meter to which it is connected.

5. A fuel dispenser as claimed in claim 1, wherein said barrier is a physical barrier.

6. A fuel dispenser as claimed in claim 1, wherein the barrier is a separating distance between the fuel-handling compartment and the electronics compartment.

7. A fuel dispenser as claimed in claim 2, wherein the barrier is a separating distance between the fuel-handling compartment and the electronics compartment.

8. A fuel dispenser as claimed in claim 3, wherein the barrier is a separating distance between the fuel-handling compartment and the electronics compartment.

9. A fuel dispenser as claimed in claim 4, wherein the barrier is a separating distance between the fuel-handling compartment and the electronics compartment.

10. A method of compensating a measured fuel flow for a temperature of the fuel in a fuel dispenser having a fuel-handling compartment and an electronics compartment and a barrier separating said compartments, said method comprising the steps of:
measuring the fuel flow,
measuring the temperature of the fuel,
compensating the measured fuel flow for the measured temperature, and
sending a signal corresponding to the compensated fuel flow through an intrinsically safe passage through the barrier from the fuel-handling compartment to a control unit in the electronics compartment.
